(19) United States
(12) Patent Application Publication
(10) Pub. No.: US 2025/0111372 A1
(43) Pub. Date: Apr. 3, 2025

(54) NOTIFICATION OF DATA TRANSACTION BASED ON TIME DIFFERENCE

(71) Applicant: Motorola Mobility LLC, Chicago, IL (US)

(72) Inventors: Krishnan Raghavan, Bangalore (IN); Nakul Patel, Bangalore (IN); Vignesh Karthik Mohan, Bangalore (IN)

(73) Assignee: Motorola Mobility LLC, Chicago, IL (US)

(21) Appl. No.: 18/375,379

(22) Filed: Sep. 29, 2023

(51) Int. Cl. G06Q 20/40

(52) U.S. Cl. CPC G06Q 20/4016

(57) ABSTRACT

Techniques for notification of data transaction based on time difference are described and are implementable to enable and disable presentation of delay alerts of delayed notifications of data transactions. For instance, a transaction notification of a data transaction is received at a client device. A comparison is performed of a time difference between a delivery time of the transaction notification and a transaction timestamp for the data transaction to a time difference threshold. The transaction notification is processed based at least in part on the comparison of the time difference to the time difference threshold, such as to present a delay alert if the transaction notification is delivered more than a threshold time duration after the data transaction.

### BACKGROUND

The use of network-based finance systems has become commonplace across the world. For instance, users can perform a wide variety of different financial transactions using a network-based finance application, such as using a portable device, e.g., a smartphone. While the availability of finance applications can provide a great deal of convenience, it is not without risks. For instance, users may engage in financial transactions that the users may subsequently forget. Thus, when delayed notifications of the data transactions are delivered to the users, this may cause undue stress on the users and result in the users utilizing excess time and system resources to verify the source(s) of the data transactions.

### BRIEF DESCRIPTION OF THE DRAWINGS

Aspects of notification of data transaction based on time difference are described with reference to the following Figures. The same numbers may be used throughout to reference similar features and components shown in the Figures. Further, identical numbers followed by different letters reference different instances of features and components described herein.

FIG. 1 illustrates an example environment in which aspects of notification of data transaction based on time difference can be implemented.

FIG. 2 depicts aspects of an example scenario for notification of data transaction based on time difference in accordance with one or more implementations.

FIG. 3 depicts aspects of an example scenario for notification of data transaction based on time difference in accordance with one or more implementations.

FIG. 4 illustrates a flow chart depicting an example method for notification of data transaction based on time difference in accordance with one or more implementations.

FIG. 5 illustrates a flow chart depicting an example method for notification of data transaction based on time difference in accordance with one or more implementations.

FIG. 6 illustrates a flow chart depicting an example method for notification of data transaction based on time difference in accordance with one or more implementations.

FIG. 7 illustrates various components of an example device in which aspects of notification of data transaction based on time difference can be implemented.

### DETAILED DESCRIPTION

Techniques for notification of data transaction based on time difference are described and are implementable to control processing of notifications of data transactions (e.g., the transfer of high priority data, financial transactions, login activity for sensitive/critical systems, etc.) based on different temporal state conditions. For instance, the described techniques enable delay alerts to be added to transaction notifications of data transactions to notify users when delivery of the transaction notifications are delayed after the data transactions.

For instance, consider a scenario in which a user performs a financial transaction (e.g., a type of data transaction) at 8 am on a Wednesday to transfer funds from the user's account to a friend's account, such as to repay the friend for borrowed funds. Later that evening (e.g., at 9 pm) the user receives via the user's mobile device a notification of the funds transfer. Having had a busy day the user has forgotten of the earlier financial transaction and is immediately in a panic that someone has gained access to the user's financial account without the user's permission. The user then checks his financial account to verify that indeed the user had performed the financial transaction earlier that day. However, in the meantime the user has experienced undue stress and has had to expend time, device resources, and network resources to verify that the financial transaction is legitimate.

Accordingly, techniques for notification of data transaction based on time difference described herein enable automatic detection of potentially delayed transaction notifications of data transactions, and presentation of delay alerts configured to alert users of the potentially delayed transaction notifications. For instance, in the scenario described above and prior to delivery of the transaction notification of the financial transaction, the described techniques can detect the delay between implementation of the financial transaction and delivery of the transaction notification. The techniques can thus be implemented to generate a delay alert and deliver the delay alert to the user's mobile device indicating that the transaction notification may represent a delayed notification of the earlier financial transaction. Thus, based on the delay alert, the user may remember the earlier financial transaction and thus avoid the stress of not knowing a source of the financial transaction as well as the work required to verify the source of the financial transaction, e.g., the user themselves.

While the example above is discussed in the context of financial transactions, it is to be appreciated that the described techniques are equally applicable to other types of data transactions, such as the transfer of sensitive data. For instance, a user may communicate (e.g., transmit) sensitive data to another device. Examples of sensitive data include security-related data (e.g., passwords, personal identification numbers (PIN), security keys, etc.), national identification numbers, proprietary and/or confidential enterprise data, health data, insurance data, etc. Accordingly, the user may be notified of delayed transaction notifications of the user's transfer of sensitive data. For instance, the various implementations detailed herein can be applied to notify users of potentially delayed notifications of transfers the sensitive data.

While features and concepts of notification of data transaction based on time difference can be implemented in any number of environments and/or configurations, aspects of the described techniques are described in the context of the following example systems, devices, and methods. Further, the systems, devices, and methods described herein are interchangeable in various ways to provide for a wide variety of implementations and operational scenarios.

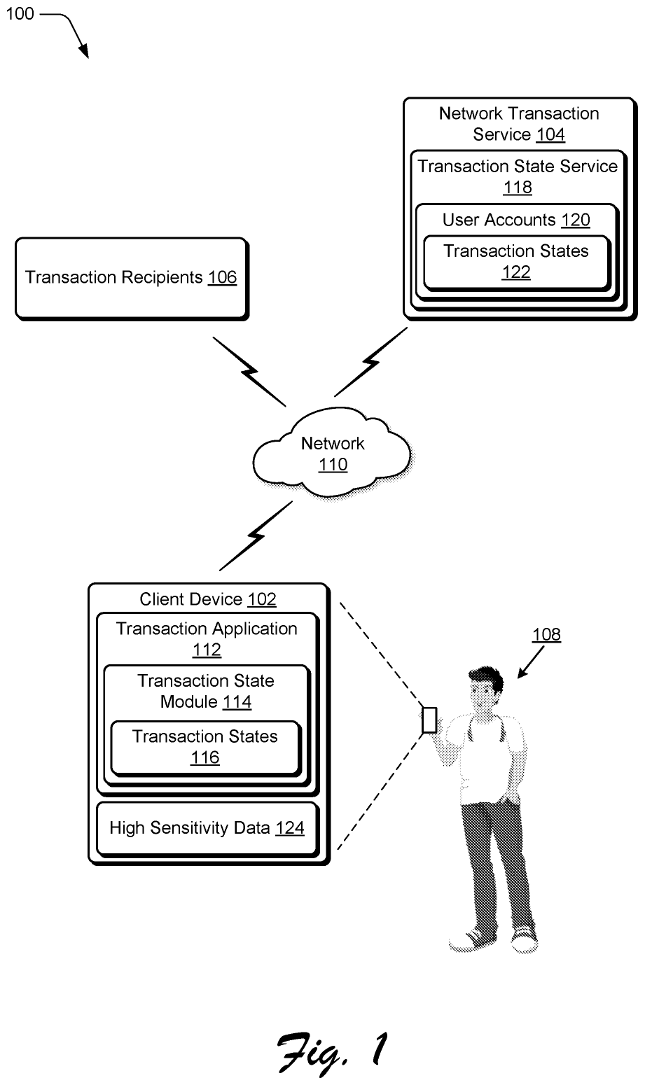

FIG. 1 illustrates an example environment 100 in which aspects of notification of data transaction based on time difference can be implemented. The environment 100 includes a client device 102, a network transaction service 104, and transaction recipients 106. The client device 102 represents a device that can be used by a user 108 to implement and manage different data transactions, e.g., finance transactions, transfer of sensitive data, etc. The client device 102 can be implemented in various ways, such as a mobile device, a desktop device, an extended reality (XR) device, and so forth. In mobile implementations, for instance, the client device 102 represents a mobile device that can be carried by the user 108 to enable the user 108 to perform data transactions at different locations.

The network transaction service 104 represents a network-based service that is accessible to the client device 102 via a network 110. The network transaction service 104 can be implemented by various entities, such as a banking entity, a payment service, an enterprise entity, a trading entity, and/or combinations thereof. The user 108, for instance, can utilize a transaction application 112 on the client device 102 to access the network transaction service 104 to perform data transactions with different transaction recipients 106. In implementations data transactions can include finance transactions, such as the transfer value amounts (e.g., monetary values) for different purposes. For example, the user 108 can interact with the transaction application 112 to purchase products, such as goods and/or services, from transaction recipients 106. Alternatively, or additionally data transactions can include other types of transactions involving the transfer of different types of data, such as a transfer of sensitive data.

Further to the environment 100 the transaction application 112 includes a transaction state module 114 which represents functionality to perform various aspects of notification of data transaction based on time difference described herein. For instance, the transaction state module 114 monitors different transaction states 116 of data transactions, such as transaction type, transaction amount, identities of transaction recipients 106, temporal attributes of data transactions (e.g., date, day, time of day, etc. of data transactions), location of the transaction, etc.

The network transaction service 104 includes various functionalities and data for aspects of notification of data transaction based on time difference, including a transaction state service 118 and user accounts 120. In implementations the transaction state service 118 can interface with the transaction state module 114 on the client device 102 to enable aspects described herein. The user accounts 120 represent information describing user profiles and user settings for different users of the network transaction service 104. The user accounts 120, for instance, include a user account 120 for the user 108 of the client device 102. The user accounts 120 include transaction states 122 which describe different state attributes of data transactions associated with different user accounts 120. Examples of the transaction states 122 include transaction type, transaction amount, identities of transaction recipients 106, temporal attributes of data transactions (e.g., date, day, time of day, etc. of data transactions), location of the transaction, etc. In implementations a user account 120 for the user 108 can include transaction states 122 that include at least some of the transaction states 116, and vice-versa.

Further to the environment 100, the client device 102 includes high sensitivity data 124 which represents sensitive (e.g., protected) data associated with the user 108 and/or the client device 102. According to implementations a data transaction can include the transfer (e.g., transmission) of the high sensitivity data 124 from the client device 102 to an external location, such as another device and/or a network location.

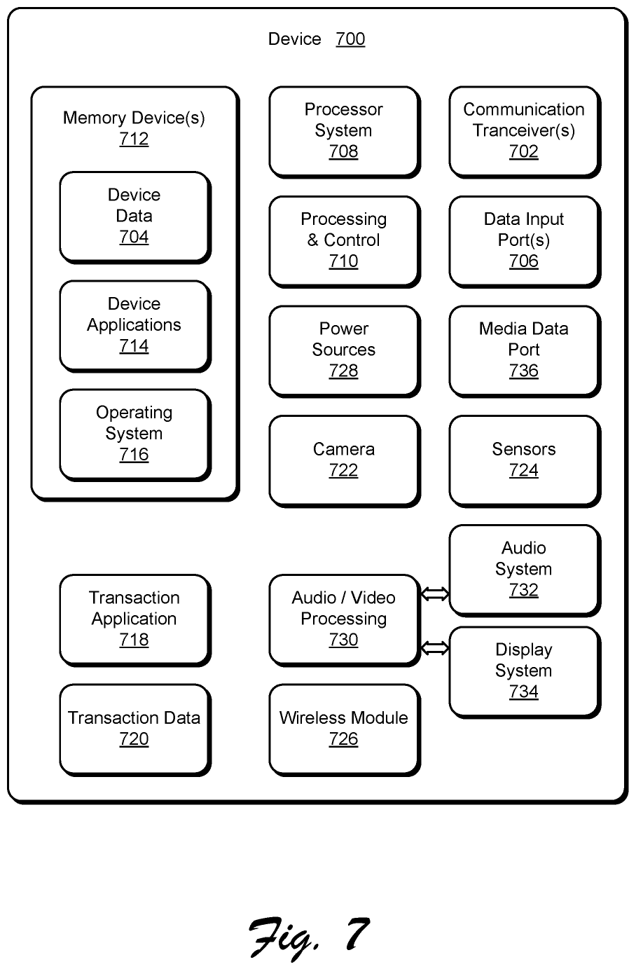

The client device 102 and the network transaction service 104 can be implemented in various ways and include various functionalities, examples of which are discussed below with reference to example device 700 of FIG. 7. Further, the network 110 can represent a combination of wired and wireless networks via which the client device 102 and the network transaction service 104 can participate in various types of communication, such as wired and/or wireless data communication.

Having discussed an example environment in which the disclosed techniques can be performed, consider now some example scenarios and implementation details for implementing the disclosed techniques.

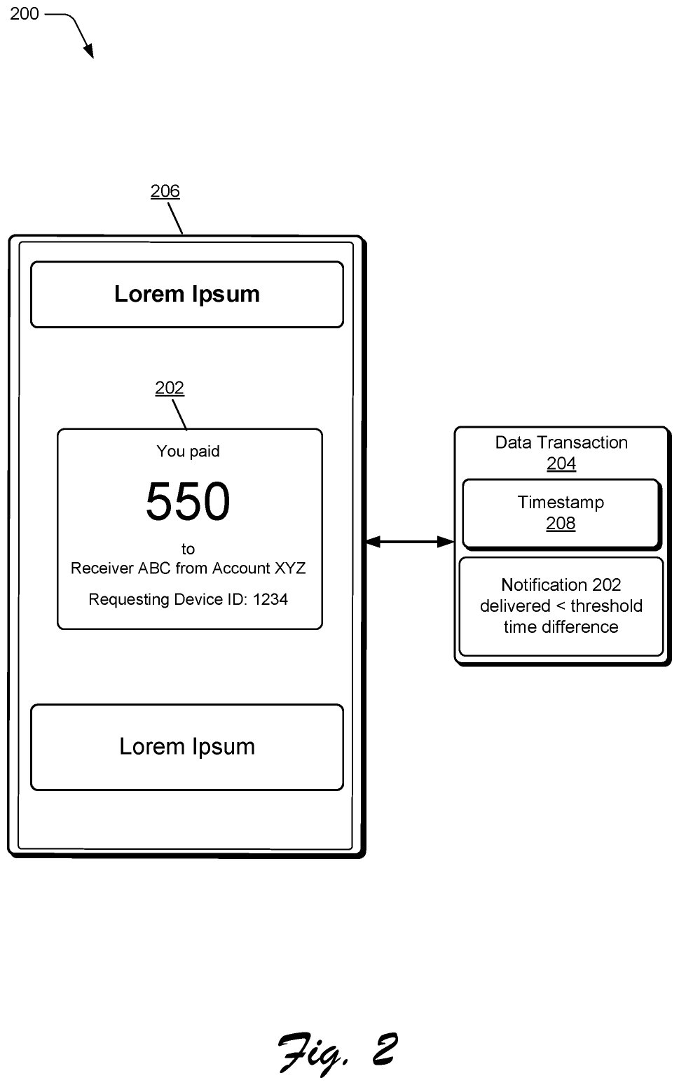

FIG. 2 depicts aspects of an example scenario 200 for notification of data transaction based on time difference in accordance with one or more implementations. The scenario 200 can be implemented in environment 100 and incorporates attributes of the environment 100 introduced above.

In the scenario 200, a transaction notification 202 of a data transaction 204 is received at a mobile device 206. The mobile device 206, for instance, represents an instance of a client device 102. In this particular example the transaction notification 202 is delivered via the mobile device 206 at a time value that is less than a threshold time period after occurrence of the data transaction 204. For instance, the data transaction 204 is associated with a timestamp 208 that identifies a time (e.g., date, day, time of day, etc.) for the data transaction 204, such as a time that the data transaction 204 is initiated, is concluded, is resolved, etc. Thus, in this implementation the transaction notification 202 is delivered via the mobile device 206 at less than a threshold time difference after a time value indicated by the timestamp 208. Further, the transaction notification 202 identifies attributes of the data transaction 204, such as an amount, a receiving party, an account from which the data transaction 204 is resolved, a device identifier (ID) for a device that initiated the data transaction 204, etc.

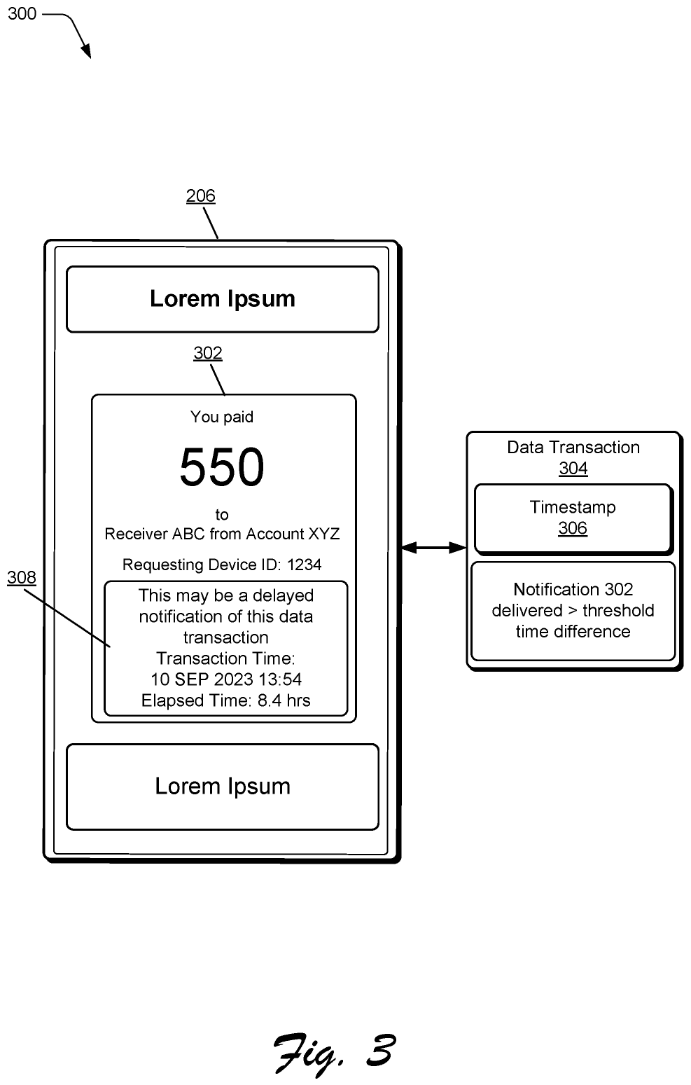

FIG. 3 depicts aspects of an example scenario 300 for notification of data transaction based on time difference in accordance with one or more implementations. The scenario 300 can be implemented in environment 100 and incorporates attributes of the environment 100 introduced above. The scenario 300, for instance, represents an additional and/or alternative implementation to the scenario 200.

In the scenario 300 a transaction notification 302 of a data transaction 304 is received at a mobile device 206. In this particular example the transaction notification 302 is delivered via the mobile device 206 at a time value that is greater than a threshold time period after occurrence of the data transaction 304. For instance, the data transaction 304 is associated with a timestamp 306 that identifies a time (e.g., date, day, time of day, etc.) for the data transaction 304, such as a time that the data transaction 304 is initiated, concluded, resolved, etc. Thus, in this implementation the transaction notification 302 is delivered via the mobile device 206 at a time that is greater than a threshold time difference after a time value indicated by the timestamp 306.

Accordingly, based at least in part on the transaction notification 302 being delivered at a time value greater than a threshold difference from a time of the data transaction 304, the transaction notification 302 is generated to include a delay alert 308 that indicates that the transaction notification 302 may represent a delayed notification of the data transaction 304. The delay alert 308, for instance, is inserted within and/or adjacent the transaction notification 302. The delay alert 308 can also include a time value for the data transaction 304, such as extracted from the timestamp 306. Further, the delay alert 308 can include an indication of an elapsed time from the data transaction 304 to delivery of the transaction notification 302. The delay alert 308 and its various components (e.g., the time value, the indication of elapsed time, etc.) can be formatted and/or presented in different ways, such as via text, color values, audio notifications, visual patterns, visual symbols, etc., to emphasize values and/or intent of the delay alert 308.

Further to the scenario 300 the transaction notification 302 identifies attributes of the data transaction 304, such as an amount, a receiving party, an account from which the data transaction 304 is resolved, a device identifier (ID) for a device that initiated the data transaction 304, etc.

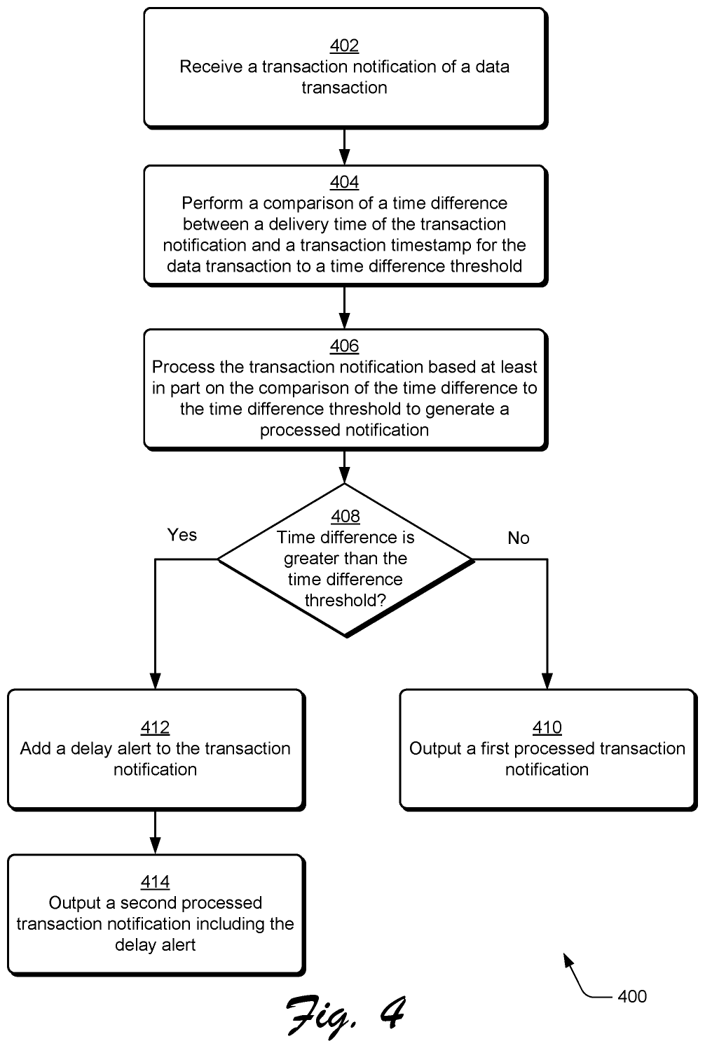

FIG. 4 illustrates a flow chart depicting an example method 400 for notification of data transaction based on time difference in accordance with one or more implementations. Operations of the method 400, for instance, may be performed in the context of the environment 100, such as by the transaction application 112 on the client device 102.

At 402 a transaction notification of a data transaction is received. The client device 102, for instance, receives a transaction notification that a data transaction has occurred, such as from the network transaction service 104. The transaction notification can include various information, such as a type of data transaction, an amount of the data transaction, data type (e.g., security level) for data involved in the data transaction, a timestamp for the data transaction, etc.

At 404 a comparison is performed of a time difference threshold to a time difference between a delivery time of the transaction notification and a transaction timestamp for the data transaction. The transaction state module 114 of the transaction application 112, for example, determines a time difference between the delivery time of the transaction notification to time value for the data transaction.

The delivery time of the transaction notification can correspond to various events, such as a time value for a time at which the transaction notification is received at the client device 102, a time value for a time at which a notification viewable trigger for the transaction notification is detected at the client device 102, and so forth. The notification viewable trigger can correspond to various events, such as a display of the transaction notification via the client device 102, detection of the user 108 being in a position to view the transaction notification while the transaction notification is displayed (e.g., via eye tracking, gaze detection, etc.), detection of user interaction with the transaction notification (e.g., user input to the transaction notification), and so forth.

A time value for the data transaction can be determined in different ways, such as via extraction of the time value from a timestamp for the data transaction, e.g., a timestamp received as part of the transaction notification. Thus, the transaction state module 114 can compare the time difference between the delivery time of the transaction notification and the time value for the data transaction to the time difference threshold.

Further, a time difference threshold can be defined in different ways, such as m minutes, h hours, etc. A time difference threshold can be defined in various ways, such as via a default system value, user interaction to configure the time difference threshold, etc.

At 406 the transaction notification is processed based at least in part on the comparison of the time difference to the time difference threshold to generate a processed notification. For instance, at 408 it is determined whether the time difference is greater than the time difference threshold. If the time difference is not greater than the time difference threshold (“No”), at 410 a first processed transaction notification is output. The first processed transaction notification, for example, includes transaction information for the data transaction, such as from the network transaction service 104. At least one example of the first processed transaction notification is discussed above with reference to the transaction notification 202.

If the time difference is greater than the time difference threshold (“Yes”), at 412 a delay alert is added to the transaction notification. The delay alert, for instance, indicates that a potential delay is detected between the data transaction and delivery of the transaction notification. At 414 a second processed transaction notification including the delay alert is output. For instance, information about the data transaction is output along with the delay alert. Further, such as mentioned above with reference to the delay alert 308, the delay alert can be formatted and/or output in different ways including textual content, other types of visual content and/or formatting, audio content, etc. At least one example of the second processed transaction notification is discussed above with reference to the transaction notification 302.

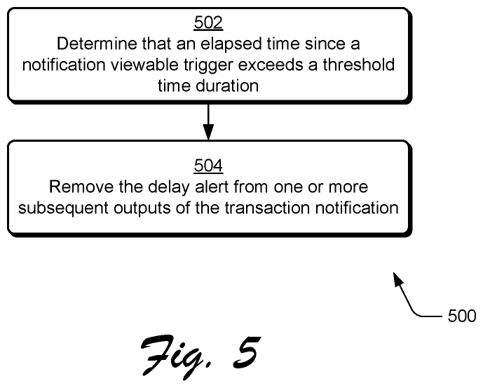

FIG. 5 illustrates a flow chart depicting an example method 500 for notification of data transaction based on time difference in accordance with one or more implementations. Operations of the method 500, for instance, may be performed in the context of the environment 100, such as by the transaction application 112 on the client device 102 and/or by the transaction state service 118 of the network transaction service 104.

At 502 it is determined that an elapsed time since a notification viewable trigger exceeds a threshold time duration. Different examples of a notification viewable trigger are discussed above and include indications that a transaction notification is viewable by a user and/or that a user is in a posture to view a transaction notification, e.g., as detected via face detection, gaze detection, etc.

At 504 the delay alert is removed from one or more subsequent outputs of the transaction notification. For instance, after the threshold time duration after a first notification viewable trigger is detected, subsequent outputs of the transaction notification do not include the delay alert, e.g., the delay alert is removed from the subsequent outputs of the transaction notification.

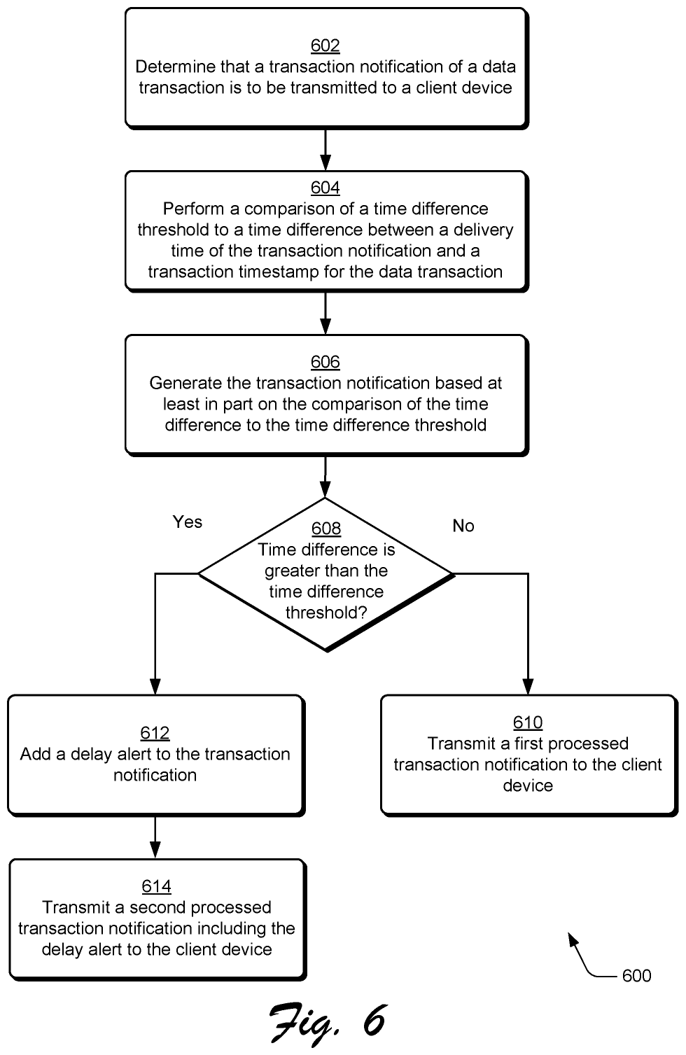

FIG. 6 illustrates a flow chart depicting an example method 600 for notification of data transaction based on time difference in accordance with one or more implementations. Operations of the method 600, for instance, may be performed in the context of the environment 100, such as by the transaction state service 118 of the network transaction service 104.

At 602 it is determined that a transaction notification of a data transaction is to be transmitted to a client device. The network transaction service 104, for instance, determines that a transaction notification of a data transaction is to be transmitted to the client device 102, e.g., for a data transaction implemented at least in part by the network transaction service 104.

At 604 a comparison of a time difference threshold to a time difference between a delivery time of the transaction notification and a transaction timestamp for the data transaction is performed. The transaction state service 118 of the network transaction service 104, for example, determines a time difference between a delivery time of the transaction notification to a time value for the data transaction, and compares the time difference to a time different threshold.

At 606 the transaction notification is generated based at least in part on the comparison of the time difference to the time difference threshold. For instance, at 608 it is determined whether the time difference is greater than the time difference threshold. If the time difference is not greater than the time difference threshold (“No”), at 610 a first processed transaction notification is transmitted to the client device. The first processed transaction notification, for example, includes transaction information for the data transaction. At least one example of the first processed transaction notification is discussed above with reference to the transaction notification 202.

If the time difference is greater than the time difference threshold (“Yes”), at 612 a delay alert is added to the transaction notification. The delay alert, for instance, indicates that a potential delay is detected between the data transaction and delivery of the transaction notification. At 614 a second processed transaction notification including the delay alert is transmitted to the client device. For instance, information about the data transaction along with the delay alert is transmitted by the network transaction service 104 to the client device 102. At least one example of the second processed transaction notification is discussed above with reference to the transaction notification 302.

In implementations the second processed transaction notification can be dynamically updated and/or modified at the client device 102. For instance, the client device 102 can receive the second processed transaction notification including the delay alert from the network transaction service 104 and can update the delay alert such as based on further delivery delay for the delay alert that occurs at the client device 102. As an example, consider a scenario where the second processed transaction notification with the delay alert is received at the client device 102 from the network transaction service 104 at a time t. Further, the delay alert indicates an elapsed time d from the data transaction to transmission of the second processed transaction notification to the client device 102. Additional delay, however, occurs at the client device 102 such that the second processed transaction notification with the delay alert is not viewable at the client device 102 for a period of time, e.g., t+n. Accordingly, the delay alert can be dynamically modified at the client device 102 (e.g., by the transaction state module 114) to update the elapsed time d (e.g., to d+n) to compensate for the additional delivery delay at the client device 102.

The example methods described above may be performed in various ways, such as for implementing different aspects of the systems and scenarios described herein. Generally, any services, components, modules, methods, and/or operations described herein can be implemented using software, firmware, hardware (e.g., fixed logic circuitry), manual processing, or any combination thereof. Some operations of the example methods may be described in the general context of executable instructions stored on computer-readable storage memory that is local and/or remote to a computer processing system, and implementations can include software applications, programs, functions, and the like. Alternatively or in addition, any of the functionality described herein can be performed, at least in part, by one or more hardware logic components, such as, and without limitation, Field-programmable Gate Arrays (FPGAs), Application-specific Integrated Circuits (ASICs), Application-specific Standard Products (ASSPs), System-on-a-chip systems (SoCs), Complex Programmable Logic Devices (CPLDs), and the like. The order in which the methods are described is not intended to be construed as a limitation, and any number or combination of the described method operations can be performed in any order to perform a method, or an alternate method.

FIG. 7 illustrates various components of an example device 700 in which aspects of notification of data transaction based on time difference can be implemented. The example device 700 can be implemented as any of the devices described with reference to the previous FIGS. 1-6, such as any type of mobile device, mobile phone, mobile device, wearable device, tablet, computing, communication, entertainment, gaming, media playback, and/or other type of electronic device. For example, the client device 102 and/or the network transaction service 104 as shown and described with reference to FIGS. 1-6 may be implemented as the example device 700.

The device 700 includes communication transceivers 702 that enable wired and/or wireless communication of device data 704 with other devices. The device data 704 can include one or more of device identifying data, device location data, wireless connectivity data, and wireless protocol data. Additionally, the device data 704 can include any type of audio, video, and/or image data. Example communication transceivers 702 include wireless personal area network (WPAN) radios compliant with various IEEE 802.15 (Bluetooth™) standards, wireless local area network (WLAN) radios compliant with any of the various IEEE 802.10 (Wi-Fi™) standards, wireless wide area network (WWAN) radios for cellular phone communication, wireless metropolitan area network (WMAN) radios compliant with various IEEE 802.16 (WiMAX™) standards, and wired local area network (LAN) Ethernet transceivers for network data communication.

The device 700 may also include one or more data input ports 706 via which any type of data, media content, and/or inputs can be received, such as user-selectable inputs to the device, messages, music, television content, recorded content, and any other type of audio, video, and/or image data received from any content and/or data source. The data input ports may include USB (Universal Serial Bus) ports, coaxial cable ports, and other serial or parallel connectors (including internal connectors) for flash memory, DVDs, CDs, and the like. These data input ports may be used to couple the device to any type of components, peripherals, or accessories such as microphones and/or cameras.

The device 700 includes a processing system 708 of one or more processors (e.g., any of microprocessors, controllers, and the like) and/or a processor and memory system implemented as a system-on-chip (SoC) that processes computer-executable instructions. The processor system may be implemented at least partially in hardware, which can include components of an integrated circuit or on-chip system, an application-specific integrated circuit (ASIC), a field-programmable gate array (FPGA), a complex programmable logic device (CPLD), and other implementations in silicon and/or other hardware. Alternatively, or in addition, the device can be implemented with any one or combination of software, hardware, firmware, or fixed logic circuitry that is implemented in connection with processing and control circuits, which are generally identified at 710. The device 700 may further include any type of a system bus or other data and command transfer system that couples the various components within the device. A system bus can include any one or combination of different bus structures and architectures, as well as control and data lines.

The device 700 also includes computer-readable storage memory 712 (e.g., memory devices) that enable data storage, such as data storage devices that can be accessed by a computing device, and that provide persistent storage of data and executable instructions (e.g., software applications, programs, functions, and the like). Examples of the computer-readable storage memory 712 include volatile memory and non-volatile memory, fixed and removable media devices, and any suitable memory device or electronic data storage that maintains data for computing device access. The computer-readable storage memory can include various implementations of random-access memory (RAM), read-only memory (ROM), flash memory, and other types of storage media in various memory device configurations. The device 700 may also include a mass storage media device.

The computer-readable storage memory 712 provides data storage mechanisms to store the device data 704, other types of information and/or data, and various device applications 714 (e.g., software applications). For example, an operating system 716 can be maintained as software instructions with a memory device and executed by the processing system 708. The device applications may also include a device manager, such as any form of a control application, software application, signal-processing and control module, code that is native to a particular device, a hardware abstraction layer for a particular device, and so on. Computer-readable storage memory 712 represents media and/or devices that enable persistent and/or non-transitory storage of information in contrast to mere signal transmission, carrier waves, or signals per se. Computer-readable storage memory 712 do not include signals per se or transitory signals.

In this example, the device 700 includes a transaction application 718 that implements aspects of notification of data transaction based on time difference and may be implemented with hardware components and/or in software as one of the device applications 714. For example, the transaction application 718 can be implemented as the transaction application 112 and/or the network transaction service 104 described in detail above. In implementations, the transaction application 718 may include independent processing, memory, and logic components as a computing and/or electronic device integrated with the device 700. The device 700 also includes transaction data 720 for implementing aspects of notification of data transaction based on time difference and may include data from the transaction application 718, such as data for managing data transaction notifications.

In this example, the example device 700 also includes a camera 722 and sensors 724. The sensors 724 can be implemented in various ways and are representative of functionality to detect various physical and/or logical phenomena in relation to the device 700, such as motion, light, image detection and recognition, time and date, position, location, touch detection, sound, temperature, and so forth. Examples of the sensors 724 include hardware and/or logical sensors such as an accelerometer, a gyroscope, a camera, a microphone, a clock, biometric sensors, touch input sensors, position sensors, environmental sensors (e.g., for temperature, pressure, humidity, and so on), geographical location information sensors (e.g., Global Positioning System (GPS) functionality), and so forth.

The device 700 also includes a wireless module 726, which is representative of functionality to perform various wireless communication tasks. The device 700 can also include one or more power sources 728, such as when the device is implemented as a mobile device. The power sources 728 may include a charging and/or power system, and can be implemented as a flexible strip battery, a rechargeable battery, a charged super-capacitor, and/or any other type of active or passive power source.

The device 700 also includes an audio and/or video processing system 730 that generates audio data for an audio system 732 and/or generates display data for a display system 734. The audio system and/or the display system may include any devices that process, display, and/or otherwise render audio, video, display, and/or image data. Display data and audio signals can be communicated to an audio component and/or to a display component via an RF (radio frequency) link, S-video link, HDMI (high-definition multimedia interface), composite video link, component video link, DVI (digital video interface), analog audio connection, or other similar communication link, such as media data port 736. In implementations, the audio system and/or the display system are integrated components of the example device. Alternatively, the audio system and/or the display system are external, peripheral components to the example device.

Although implementations of notification of data transaction based on time difference have been described in language specific to features and/or methods, the subject of the appended claims is not necessarily limited to the specific features or methods described. Rather, the features and methods are disclosed as example implementations, and other equivalent features and methods are intended to be within the scope of the appended claims. Further, various examples are described, and it is appreciated that each described example can be implemented independently or in connection with one or more other described examples. Additional aspects of the techniques, features, and/or methods discussed herein relate to one or more of the following:

In some aspects, the techniques described herein relate to a client device including: at least one processor; and one or more modules executable by the at least one processor to: receive a transaction notification of a data transaction; perform a comparison to a time difference threshold of a time difference between a delivery time of the transaction notification and a transaction timestamp for the data transaction; process the transaction notification based at least in part on the comparison of the time difference to the time difference threshold to generate a processed transaction notification; and cause the processed transaction notification to be output via the client device.

In some aspects, the techniques described herein relate to a client device, wherein the data transaction includes one or more of a data transfer pertaining to a financial transaction or a data transfer pertaining to high sensitivity data.

In some aspects, the techniques described herein relate to a client device, wherein the transaction notification includes one or more of a notification of the data transfer pertaining to the financial transaction or a notification of the data transfer pertaining to high sensitivity data.

In some aspects, the techniques described herein relate to a client device, wherein the delivery time includes a time value for a time at which the transaction notification is received at the client device.

In some aspects, the techniques described herein relate to a client device, wherein the delivery time includes a time value for a time at which a notification viewable trigger is detected at the client device.

In some aspects, the techniques described herein relate to a client device, wherein the one or more modules are executable by the at least one processor to at least one of: extract the transaction timestamp from the transaction notification; or utilize an identifier for the data transaction to obtain the transaction timestamp from a network service.

In some aspects, the techniques described herein relate to a client device, wherein: the comparison of the time difference to the time different threshold indicates that the time difference between the delivery time of the transaction notification and the transaction timestamp for the data transaction exceeds the time difference threshold; and to process the transaction notification, the one or more modules are executable by the at least one processor to add a delay alert to the transaction notification indicating a detected delay between the data transaction and the delivery time of the transaction notification.

In some aspects, the techniques described herein relate to a client device, wherein the delivery time includes a time value for an indication of a time at which a notification viewable trigger is detected at the client device, and wherein the one or more modules are executable by the at least one processor to: determine that an elapsed time since the notification viewable trigger exceeds a threshold time duration; and remove the delay alert from one or more subsequent outputs of the transaction notification.

In some aspects, the techniques described herein relate to a client device, wherein the notification viewable trigger includes an indication that the transaction notification is viewable via the client device.

In some aspects, the techniques described herein relate to a method including: receiving, at a client device, a transaction notification of a data transaction; performing a comparison, to a time difference threshold, of a time difference between a delivery time of the transaction notification and a transaction timestamp for the data transaction; processing the transaction notification based at least in part on the comparison of the time difference to the time difference threshold; and causing the processed notification to be output via the client device.

In some aspects, the techniques described herein relate to a method, wherein the delivery time includes one or more of: a time value for a time at which the transaction notification is received at the client device; or a time value for a time at which a notification viewable trigger is detected at the client device.

In some aspects, the techniques described herein relate to a method, wherein: the comparison of the time difference to the time different threshold indicates that the time difference between the delivery time of the transaction notification and the transaction timestamp for the data transaction exceeds the time difference threshold; and processing the transaction notification includes adding a delay alert to the transaction notification indicating a detected delay between the data transaction and the delivery time of the transaction notification.

In some aspects, the techniques described herein relate to a method, wherein the delivery time includes a time value for an indication of a time at which a notification viewable trigger is detected at the client device, and wherein the method further includes: determining that an elapsed time since the notification viewable trigger exceeds a threshold time duration; and removing the delay alert from one or more subsequent instances of the transaction notification.

In some aspects, the techniques described herein relate to a system including: at least one memory; and at least one processor coupled to the at least one memory and configured to cause the system to: determine that a transaction notification of a data transaction is to be transmitted to a client device; perform a comparison, to a time difference threshold, of a time difference between a delivery time for the transaction notification and a transaction timestamp for the data transaction; generate the transaction notification based at least in part on the comparison of the time difference to the time difference threshold; and transmit the transaction notification to the client device.

In some aspects, the techniques described herein relate to a system, wherein the data transaction includes one or more of a data transfer pertaining to a financial transaction or a data transfer pertaining to high sensitivity data.

In some aspects, the techniques described herein relate to a system, wherein the delivery time includes a time value for a time at which the transaction notification is transmitted to the client device.

In some aspects, the techniques described herein relate to a system, wherein the delivery time includes a time value for a time at which a notification viewable trigger is detected at the client device.

In some aspects, the techniques described herein relate to a system, wherein: the comparison of the time difference to the time different threshold indicates that the time difference between the delivery time of the transaction notification and the transaction timestamp for the data transaction exceeds the time difference threshold; and to generate the transaction notification, the at least one processor is configured to cause the system to add a delay alert to the transaction notification indicating a detected delay between the data transaction and the delivery time of the transaction notification.

In some aspects, the techniques described herein relate to a system, wherein the delivery time includes a time value for an indication of a time at which a notification viewable trigger is detected at the client device, and wherein the at least one processor is configured to cause the system to: determine that an elapsed time since the notification viewable trigger exceeds a threshold time duration; and remove the delay alert from one or more subsequent instances of the transaction notification.

In some aspects, the techniques described herein relate to a system, wherein the notification viewable trigger includes an indication that the transaction notification is viewable via the client device.

1. A client device comprising:
at least one processor; and
one or more modules executable by the at least one processor to:
receive a transaction notification of a data transaction;
perform a comparison to a time difference threshold of a time difference between a delivery time of the transaction notification and a transaction timestamp for the data transaction;
process the transaction notification based at least in part on the comparison of the time difference to the time difference threshold to generate a processed transaction notification; and
cause the processed transaction notification to be output via the client device.

2. The client device of claim 1, wherein the data transaction comprises one or more of a data transfer pertaining to a financial transaction or a data transfer pertaining to high sensitivity data.

3. The client device of claim 2, wherein the transaction notification comprises one or more of a notification of the data transfer pertaining to the financial transaction or a notification of the data transfer pertaining to high sensitivity data.

4. The client device of claim 1, wherein the delivery time comprises a time value for a time at which the transaction notification is received at the client device.

5. The client device of claim 1, wherein the delivery time comprises a time value for a time at which a notification viewable trigger is detected at the client device.

6. The client device of claim 1, wherein the one or more modules are executable by the at least one processor to at least one of:
extract the transaction timestamp from the transaction notification; or
utilize an identifier for the data transaction to obtain the transaction timestamp from a network service.

7. The client device of claim 1, wherein:
the comparison of the time difference to the time different threshold indicates that the time difference between the delivery time of the transaction notification and the transaction timestamp for the data transaction exceeds the time difference threshold; and
to process the transaction notification, the one or more modules are executable by the at least one processor to add a delay alert to the transaction notification indicating a detected delay between the data transaction and the delivery time of the transaction notification.

8. The client device of claim 7, wherein the delivery time comprises a time value for an indication of a time at which a notification viewable trigger is detected at the client device, and wherein the one or more modules are executable by the at least one processor to:
determine that an elapsed time since the notification viewable trigger exceeds a threshold time duration; and
remove the delay alert from one or more subsequent outputs of the transaction notification.

9. The client device of claim 8, wherein the notification viewable trigger comprises an indication that the transaction notification is viewable via the client device.

10. A method comprising:
receiving, at a client device, a transaction notification of a data transaction;
performing a comparison, to a time difference threshold, of a time difference between a delivery time of the transaction notification and a transaction timestamp for the data transaction;
processing the transaction notification based at least in part on the comparison of the time difference to the time difference threshold; and
causing the processed notification to be output via the client device.

11. The method of claim 10, wherein the delivery time comprises one or more of:
a time value for a time at which the transaction notification is received at the client device; or
a time value for a time at which a notification viewable trigger is detected at the client device.

12. The method of claim 10, wherein:
the comparison of the time difference to the time different threshold indicates that the time difference between the delivery time of the transaction notification and the transaction timestamp for the data transaction exceeds the time difference threshold; and
processing the transaction notification comprises adding a delay alert to the transaction notification indicating a detected delay between the data transaction and the delivery time of the transaction notification.

13. The method of claim 12, wherein the delivery time comprises a time value for an indication of a time at which a notification viewable trigger is detected at the client device, and wherein the method further comprises:
determining that an elapsed time since the notification viewable trigger exceeds a threshold time duration; and
removing the delay alert from one or more subsequent instances of the transaction notification.

14. A system comprising:
at least one memory; and
at least one processor coupled to the at least one memory and configured to cause the system to:
determine that a transaction notification of a data transaction is to be transmitted to a client device;
perform a comparison, to a time difference threshold, of a time difference between a delivery time for the transaction notification and a transaction timestamp for the data transaction;
generate the transaction notification based at least in part on the comparison of the time difference to the time difference threshold; and
transmit the transaction notification to the client device.

15. The system of claim 14, wherein the data transaction comprises one or more of a data transfer pertaining to a financial transaction or a data transfer pertaining to high sensitivity data.

16. The system of claim 14, wherein the delivery time comprises a time value for a time at which the transaction notification is transmitted to the client device.

17. The system of claim 14, wherein the delivery time comprises a time value for a time at which a notification viewable trigger is detected at the client device.

18. The system of claim 14, wherein:
the comparison of the time difference to the time different threshold indicates that the time difference between the delivery time of the transaction notification and the transaction timestamp for the data transaction exceeds the time difference threshold; and
to generate the transaction notification, the at least one processor is configured to cause the system to add a delay alert to the transaction notification indicating a detected delay between the data transaction and the delivery time of the transaction notification.

19. The system of claim 18, wherein the delivery time comprises a time value for an indication of a time at which a notification viewable trigger is detected at the client device, and wherein the at least one processor is configured to cause the system to:
determine that an elapsed time since the notification viewable trigger exceeds a threshold time duration; and
remove the delay alert from one or more subsequent instances of the transaction notification.

20. The system of claim 19, wherein the notification viewable trigger comprises an indication that the transaction notification is viewable via the client device.
